(19) United States
(12) Patent Application Publication
(10) Pub. No.: US 2025/0317539 A1
(43) Pub. Date: Oct. 9, 2025

(54) LIGHT VALVE MODULE AND PROJECTION DEVICE

(71) Applicant: Coretronic Corporation, Hsin-Chu (TW)

(72) Inventors: Tung-Chou Hu, Hsin-Chu (TW); Wei-Min Chien, Hsin-Chu (TW)

(73) Assignee: Coretronic Corporation, Hsin-Chu (TW)

(21) Appl. No.: 19/060,790

(22) Filed: Feb. 24, 2025

(30) Foreign Application Priority Data
Apr. 3, 2024 (CN) 202410399443.6

(51) Int. Cl. H04N 9/31

(52) U.S. Cl. CPC H04N 9/3144; H04N 9/317; H04N 9/3197

(57) ABSTRACT

A light valve module and a projection device are provided. The light valve module includes a shell, an optical sheet, a transmissive light valve, and a heat dissipation module. An airflow channel is situated between the optical sheet and the transmissive light valve. The heat dissipation module includes a cooling fan, a refrigeration element, and a heat exchange element. An air outlet of the cooling fan communicates with an entrance port of the airflow channel. A cold surface of the refrigeration element is connected to the heat exchange element and faces an exit port of the airflow channel. The heat exchange element is located between the refrigeration element and the exit port of the airflow channel. An air inlet of the cooling fan faces the extension end of the heat exchange element.

### CROSS-REFERENCE TO RELATED APPLICATION

This application claims the priority benefit of China application serial no. 202410399443.6, filed on Apr. 3, 2024. The entirety of the above-mentioned patent application is hereby incorporated by reference herein and made a part of this specification.

### BACKGROUND

### Technical Field

The disclosure relates to an optical device; more particularly, the disclosure relates to a light valve module and a projection device.

### Description of Related Art

One liquid crystal display (one LCD) projectors tend to retain most of heat energy inside an optical engine due to their low optical efficiency. According to conventional technology, an open optical engine design is adopted and introduce cold airflow from the outside through the optical engine for cooling. However, this approach easily allows external dust entering the optical engine to contaminate optical elements and results in low reliability, a short lifespan, and decreased projection quality. Currently, to avoid dust contamination, a sealed optical engine design is adopted together with a heatsink that penetrates the optical engine, allowing the heat inside the optical engine to be transferred to the outside through the heatsink, and heat exchange is performed through a system fan. Compared with the open optical engine design, the sealed optical engine design cannot remove heat through direct convection and is required to conduct the heat from the inside of the optical engine to the outside and thus makes it less efficient. Besides, achieving the same heat dissipation effect requires a relatively large volume. In addition, although the sealed optical engine design has better resolved the dust ingress issue, the airflow temperature cannot be maintained at as low an external temperature as in the open optical engine, and therefore the brightness of the sealed optical engine is not as high as that of the open optical engine, posing a limitation to the maximum brightness of the projector.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

An embodiment of the disclosure provides a light valve module that is adapted to be connected to a lens module. The light valve module includes a shell, an optical sheet, a transmissive light valve, and a first heat dissipation module. The shell is connected to the lens module. The optical sheet is disposed in the shell. The transmissive light valve is disposed in the shell, where a first airflow channel is situated between the optical sheet and the transmissive light valve. The first heat dissipation module is disposed in the shell and includes a cooling fan, a refrigeration element, and a first heat exchange element. The cooling fan includes an air outlet and an air inlet. The air outlet communicates with a first entrance port of the first airflow channel. A cold surface of the refrigeration element is connected to the first heat exchange element and faces a first exit port of the first airflow channel. The first heat exchange element is located between the refrigeration element and the first exit port of the first airflow channel. A length of the first heat exchange element extends in a first direction. In the first direction, a maximum distance from an edge of an extension end of the first heat exchange element to the optical sheet is greater than or equal to a distance from an optical axis of the lens module to the optical sheet. The air inlet of the cooling fan faces the extension end of the first heat exchange element.

An embodiment of the disclosure provides a projection device that includes a light source module, a light valve module, and a lens module. The light source module is configured to provide an illumination beam. The light valve module includes a shell, an optical sheet, a transmissive light valve, and a first heat dissipation module. The shell is connected to the lens module. The optical sheet is disposed in the shell. The transmissive light valve is disposed in the shell and located on a transmission path of the illumination beam for converting the illumination beam into an image beam. A first airflow channel is situated between the optical sheet and the transmissive light valve. The first heat dissipation module is disposed in the shell and includes a cooling fan, a refrigeration element, and a first heat exchange element. The cooling fan includes an air outlet and an air inlet. The air outlet communicates with a first entrance port of a first airflow channel. A cold surface of the refrigeration element is connected to the first heat exchange element and faces a first exit port of the first airflow channel. The first heat exchange element is located between the refrigeration element and the first exit port of the first airflow channel. The lens module is disposed on a transmission path of the image beam, and at least one portion of the lens module is disposed in the shell. The lens module is configured to project the image beam out of the projection device, where a length of the first heat exchange element extends in a first direction. In the first direction, a maximum distance from an edge of an extension end of the first heat exchange element to the optical sheet is greater than or equal to a distance from an optical axis of the lens module to the optical sheet. The air inlet of the cooling fan faces the extension end of the first heat exchange element.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings, which are included to provide a further understanding of the disclosure, are incorporated in and constitute a part of this specification. The drawings illustrate embodiments of the disclosure and, together with the description, serve to explain the principles of the disclosure.

FIG. 1A is a schematic three-dimensional top view of a projection device according to an embodiment of the disclosure.

FIG. 1B is a schematic three-dimensional bottom view of the projection device in FIG. 1A.

FIG. 1C is a schematic cross-sectional view taken along the line I-I in FIG. 1B.

FIG. 1D is another schematic partial cross-sectional view of the projection device in FIG. 1A.

FIG. 2A is a schematic three-dimensional top view of a projection device according to another embodiment of the disclosure.

FIG. 2B is a schematic three-dimensional bottom view of the projection device in FIG. 2A.

FIG. 2C is a schematic cross-sectional view taken along the line II-II in FIG. 2B.

FIG. 3A is a schematic three-dimensional top view of a projection device according to another embodiment of the disclosure.

FIG. 3B is a schematic three-dimensional bottom view of the projection device in FIG. 3A.

FIG. 4A is a schematic cross-sectional view of a projection device according to another embodiment of the disclosure.

FIG. 4B is a schematic view of a cooling fan in the projection device in FIG. 4A.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

A light valve module provided in one or more embodiments of the disclosure may achieve good heat dissipation effects.

A projection device provided in one or more embodiments of the disclosure includes the above-mentioned light valve module and may have good imaging quality.

Other objectives and advantages of the invention may further be learned from technical features disclosed in the disclosure.

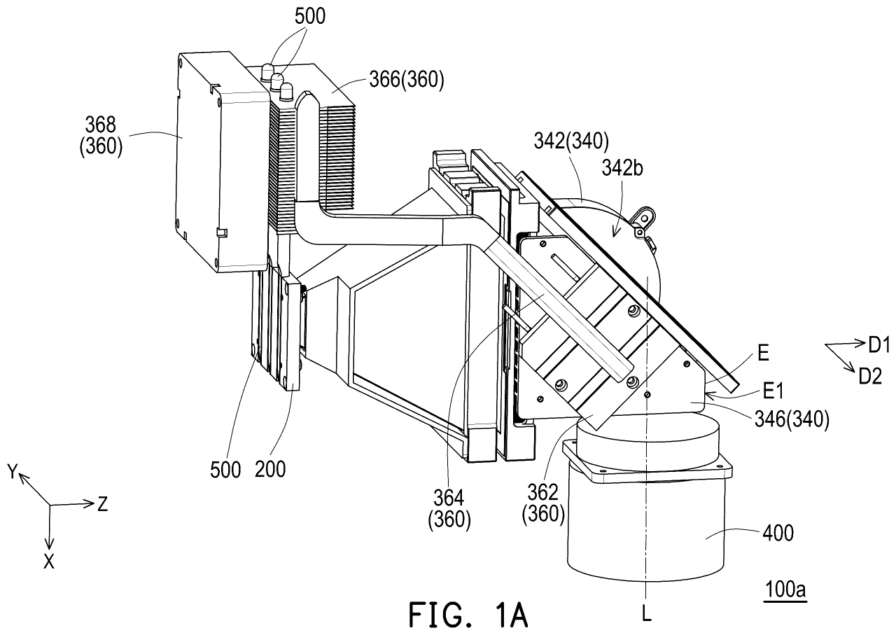

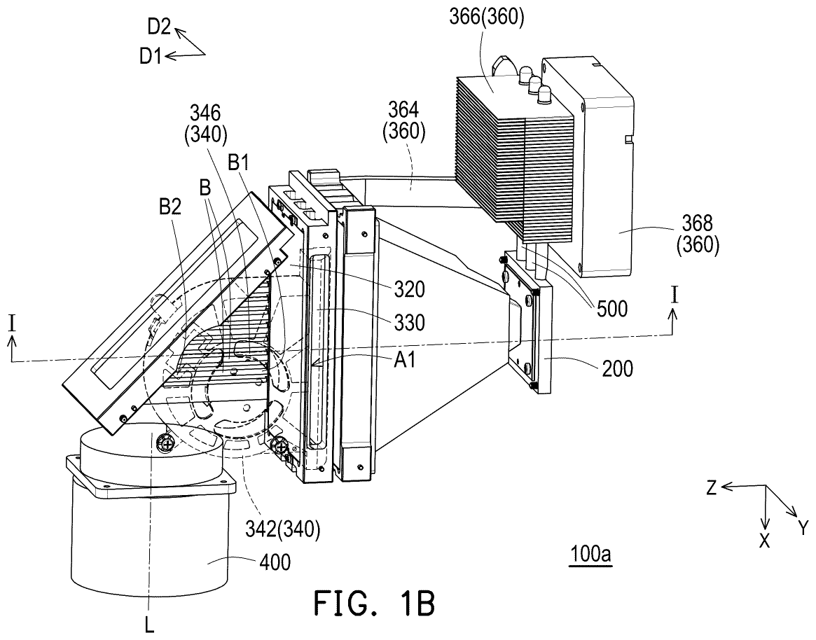

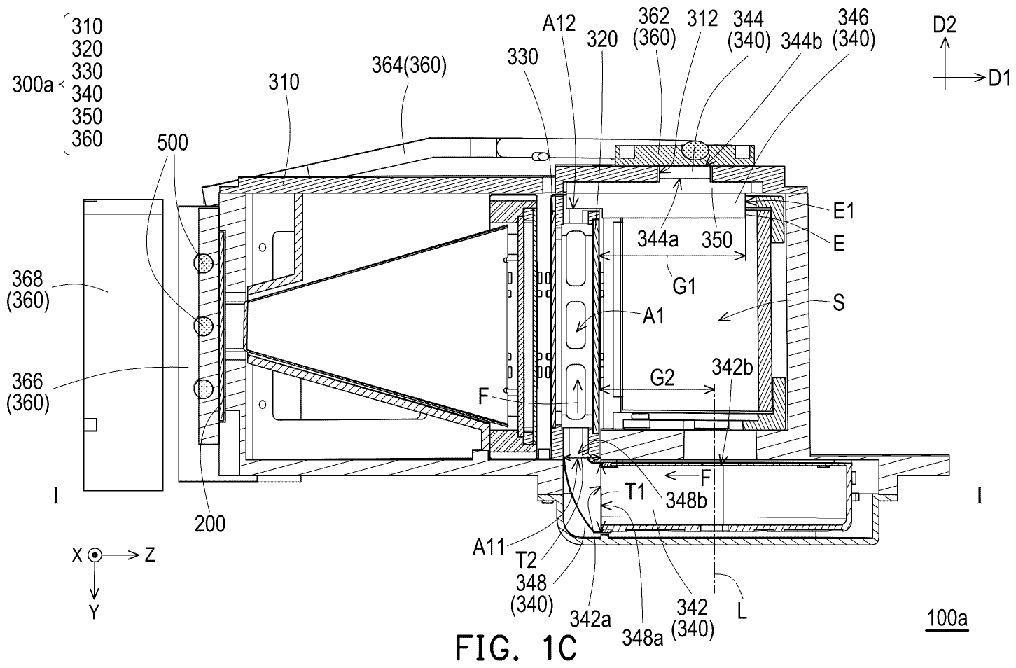

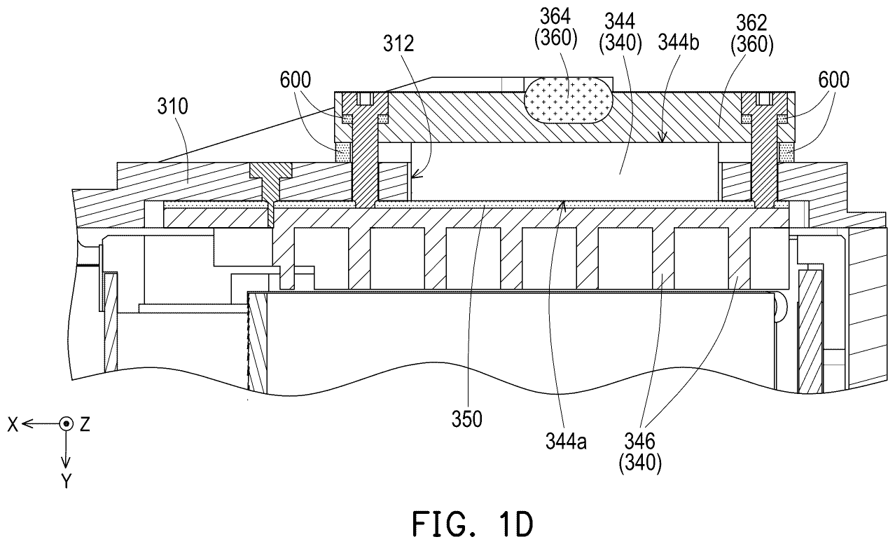

FIG. 1A is a schematic three-dimensional top view of a projection device according to an embodiment of the disclosure. FIG. 1B is a schematic three-dimensional bottom view of the projection device in FIG. 1A. FIG. 1C is a schematic cross-sectional view taken along the line I-I in FIG. 1B. FIG. 1D is another schematic partial cross-sectional view of the projection device in FIG. 1A. It should be noted that, for the sake of clarity and ease of explanation, some components, such as a shell, are omitted from FIG. 1A and FIG. 1B, and some components are represented by dashed lines, such as a fan.

With reference to FIG. 1A, FIG. 1B, and FIG. 1C, in the present embodiment, a projection device 100a includes a light source module 200, a light valve module 300a, and a lens module 400. The light source module 200 is configured to provide an illumination beam. The light valve module 300a is disposed on a transmission path of the illumination beam to convert the illumination beam into an image beam. The lens module 400 is disposed on a transmission path of the image beam to project the image beam out of the projection device 100a.

In an embodiment, the light source module 200 may include one or more light-emitting elements, and the light-emitting elements are, for instance, one or more laser diodes (LD), one or more light-emitting diodes (LED), or a combination of the two types of light sources. Specifically, any light source that meets the volume requirements in actual design may be implemented, which should not be construed as a limitation to the disclosure. In an embodiment, the light valve module 300a may include a transmissive light valve 330, such as a transparent liquid crystal panel, an electro-optical modulator, a magneto-optic modulator, an acousto-optic modulator (AOM), and so on. A method by which the light valve of the light valve module 300a converts the illumination beam into the image beam, the detailed steps of the method, and how to implement the method may be sufficiently taught, suggested and implemented by the common knowledge of the pertinent technical field and thus will not be further described. The lens module 400 may include a combination of one or more optical lenses with refractive power, such as a combination of various non-planar lenses including biconcave lenses, biconvex lenses, concave-convex lenses, convex-concave lenses, plano-convex lenses, and plano-concave lenses. In an embodiment, the lens module 400 may further include a planar optical lens, which reflects or transmits the image beam from the transmissive light valve 330 into a projection beam and projects the projection beam out of the projection device 100a. Here, the form and the type of the lens module 400 are not limited in the present embodiment.

Specifically, with reference to FIG. 1A, FIG. 1B, and FIG. 1C, in the present embodiment, the light valve module 300a includes a shell 310, an optical sheet 320, a transmissive light valve 330, and a first heat dissipation module 340. The light valve module 300a is connected to the lens module 400 through the shell 310. The optical sheet 320 is disposed in the shell 310. The transmissive light valve 330 is disposed in the shell 310 and is located on the transmission path of the illumination beam for converting the illumination beam into the image beam. A first airflow channel Al is situated between the optical sheet 320 and the transmissive light valve 330. The first heat dissipation module 340 is disposed in the shell 310. The first heat dissipation module 340 includes a cooling fan 342, a refrigeration element 344, and a first heat exchange element 346. The cooling fan 342 includes an air outlet 342a and an air inlet 342b. The air outlet 342a communicates with a first entrance port All of the first airflow channel A1. A cold surface 344a of the refrigeration element 344 is connected to the first heat exchange element 346 and faces a first exit port A12 of the first airflow channel A1. The first heat exchange element 346 is located between the refrigeration element 344 and the first exit port A12 of the first airflow channel A1. At least one portion of the lens module 400 is disposed in the shell 310. A length of the first heat exchange element 346 extends in a first direction D1. In the first direction D1, a maximum distance G from an edge E1 of an extension end E of the first heat exchange element 346 to the optical sheet 320 is greater than or equal to a distance G2 from an optical axis L of the lens module 400 to the optical sheet 320. The air inlet 342b of the cooling fan 342 faces the extension end E of the first heat exchange element 346.

In detail, according to the present embodiment, the shell 310 has an opening 312, and the refrigeration element 344 is positioned corresponding to the opening 312, where a hot surface 344b of the refrigeration element 344 faces outward from the shell 310. Specifically, the shell 310, the refrigeration element 344, the first heat exchange element 346, and one portion of the lens module 400 define a sealed chamber S. To be specific, the opening 312 of the shell 310 is larger in size than the refrigeration element 344, and the first heat exchange element 346 connected to the refrigeration element 344 may block a gap between the opening 312 and the refrigeration element 344 to close the opening 312. In the present embodiment, arranging the refrigeration element 344 and the first heat exchange element 346 enables sealing of the shell 310 to form the sealed chamber S, thus achieving a dust-proof effect. In other words, the light valve module 300a provided in the present embodiment may be regarded as a design of a closed optical engine; that is, the airflow inside the light valve module 300a is isolated from the airflow outside the light valve module 300a.

Moreover, the optical sheet 320 in this embodiment may be, for instance, an optical lens or a polarizer, which should not be construed as a limitation to the disclosure. In an embodiment, when the illumination beam incident to the light valve module 300a is polarized light, the optical sheet 320 may be an optical lens (such as a Fresnel lens) for collimating the illumination beam into parallel light. In an embodiment, if the illumination beam is non-polarized light, a polarizer may be additionally disposed between the optical lens and the transmissive light valve 330 to polarize the illumination beam, and the optical sheet 320 here refers to the polarizer. In the present embodiment, the optical sheet 320 refers to the optical lens, and the first airflow channel Al is situated between the optical sheet 320 and the transmissive light valve 330.

Next, with reference to FIG. 1B and FIG. 1C, in the present embodiment, the cooling fan 342 is disposed at the bottom of the shell 310. The cooling fan 342 is, for instance, a blower fan, but this should not be construed as a limitation to the disclosure. The first heat exchange element 346 is disposed at the top of the shell 310 and has at least one air passage B (a plurality of air passages are schematically shown in FIG. 1B). In an embodiment, the first heat exchange element 346 may be, for instance, a heatsink set, including a plurality of heatsinks spaced from each other, such as needle-shaped heatsinks or plate-shaped heatsinks, which should not be construed as a limitation to the disclosure. Additionally, an air passage B is formed between each pair of adjacent heatsinks. A direction from an entrance B1 to an exit B2 of each air passage B is parallel to the first direction D1, where the first direction D1 is perpendicular to a second direction D2 extended by the first airflow channel A1, thereby enabling an airflow F from the first airflow channel A1 to perform impingement cooling on the first heat exchange element 346, so as to achieve effective heat exchange to lower the temperature of the airflow F inside the shell 310.

With reference to FIG. 1C, the first heat dissipation module 340 provided in the present embodiment further includes an air guiding pipe 348, and the air guiding pipe 348 is a bent pipe and has a first end 348a and a second end 348b. The first end 348a is connected to the air outlet 342a of the cooling fan 342, and the second end 348b is connected to the first entrance port A11 of the first airflow channel A1. A diameter T1 of the first end 348a may be larger than a diameter T2 of the second end 348b, which reduces flow resistance. The flow resistance is effectively reduced through the design of tapered diameter.

Next, with reference to FIG. 1D, the light valve module 300a provided in the present embodiment further includes a thermal interface material 350, and the thermal interface material 350 is disposed between the first heat exchange element 346 and the cold surface 344a of the refrigeration element 344, and/or is disposed between the first heat exchange element 346 and the shell 310. The first heat exchange element 346 is connected to the refrigeration element 344a through the thermal interface material 350.

As shown in FIG. 1C, the air inlet 342b of the cooling fan 342 faces the extension end E of the first heat exchange element 346, and the other end of the first heat exchange element 346 relative to the extension end E is connected to the first outlet port A12 of the first airflow channel A1. The airflow F provided by the cooling fan 342 flows from the first inlet port A11 of the first airflow channel Al to the first outlet port A12 through the air guiding pipe 348, and flows in an impingement cooling manner through the first heat exchange element 346 connected to the cold surface 344a of the refrigeration element 344. The airflow F is allowed to flow along the air passage B of the first heat exchange element 346 towards the edge E1 of the extension end E and the bottom of the shell 310, and the airflow F finally enters the cooling fan 342 again due to a suction force of the air inlet 342b of the cooling fan 342, thus completing the cooling circulation inside the light valve module 300a and accordingly dissipating heat from the transmissive light valve 330.

In addition, with reference to FIG. 1A, FIG. 1B, and FIG. 1C, to achieve good heat dissipation, the light valve module 300a provided in the present embodiment may further include a second heat dissipation module 360 positioned external to the shell 310. Specifically, the second heat dissipation module 360 includes a thermal conductive substrate 362, a light valve thermal conductive member 364, a second heat exchange element 366, and a system fan 368. The thermal conductive substrate 362 is connected to the hot surface 344b of the refrigeration element 344. The light valve thermal conductive member 364 is connected to the thermal conductive substrate 362 and the second heat exchange element 366. The system fan 368 is disposed on one side of the second heat exchange element 366 to generate airflow to reduce the temperature through the second heat exchange element 366. In an embodiment, the second heat exchange element 366 may be, for instance, a heatsink, such as a needle-shaped heatsink or a plate-shaped heatsink, which should not be construed as a limitation to the disclosure. In an embodiment, the system fan 368 is, for instance, an axial fan, which should not be construed as a limitation to the disclosure.

Besides, the projection device 100a provided in the present embodiment may further include a light source thermal conductive member 500 connected to the light source module 200 and the second heat exchange element 366. That is, the light source module 200 and the light valve module 300a provided in the present embodiment may share the same heat exchange element, i.e., the second heat exchange element 366, for heat dissipation, thus effectively reducing the overall volume of the projection device 100a. The light source thermal conductive member 500, in one embodiment, may be a heat pipe; however, this should not be construed as a limitation to the disclosure.

With reference to FIG. 1D, the projection device 100a provided in the present embodiment further includes at least one thermal barrier (schematically shown as a plurality of thermal barriers 600) disposed between the first heat dissipation module 340 and the second heat dissipation module 360. The thermal barriers 600 are located between the shell 310 and the thermal conductive substrate 362 of the second heat dissipation module 360 and/or in the connection interface between the first heat exchange element 346 of the first heat dissipation module 340 and the thermal conductive substrate 362 of the second heat dissipation module 360. Specifically, in this embodiment, the thermal conductive substrate 362 and the first heat exchange element 346 are connected and fixed by screws, and the connection interface, for instance, refers a surface where the screws contact the thermal conductive substrate 362. In an embodiment, the thermal barrier may include a thermal insulation pad, a thermal insulation sleeve, or a screw made of a material with a low thermal conductivity coefficient (such as K≤1). However, this should not be construed as a limitation to the disclosure. The thermal barriers 600 may prevent heat from being transferred from the second heat dissipation module 360 to the first heat dissipation module 340.

In brief, according to the present embodiment, the internal temperature of the light valve module 300a may be reduced through the arrangement of the first heat dissipation module 340, thereby dissipating heat from the transmissive light valve 330 and ensuring the light valve module 300a provided in this embodiment to have good heat dissipation performance, and the brightness may be further enhanced. Moreover, on a flow path of the airflow F, the first heat exchange element 346 is located downstream of the transmissive light valve 330, thus allowing the high-temperature air leaving the transmissive light valve 330 to directly blow onto the first heat exchange element 346, thus effectively reducing the airflow temperature inside the light valve module 300a. Moreover, the air passage B (the first direction D1) of the first heat exchange element 346 is perpendicular to the first airflow channel A1 (the second direction D2), thus achieving heat exchange through impingement cooling. In addition, the hot surface 344b of the refrigeration element 344 conducts heat to the second heat exchange element 366 outside the shell 310 through the light valve thermal conductive member 364 and the thermal conductive substrate 362 and reduces the temperature through the system fan 368, thus preventing the heat of the hot surface 344b of the refrigeration element 344 from heating the light valve module 300a and accordingly ensuring good imaging quality of the projection device 100a provided in this embodiment. Furthermore, the shell 310, the refrigeration element 344, the first heat exchange element 346, and one portion of the lens module 400 define the sealed chamber S, thus realizing a closed design for the light valve module 300a provided this embodiment and achieving a dustproof effect.

Other embodiments are provided hereinafter for further explanation. Note that the reference numbers and a part of the contents in the previous embodiment are used in the following embodiments, in which identical reference numbers indicate identical or similar components, and the description of similar technical content should be referenced to the above-mentioned embodiments and thus will not be repeated in the following embodiments.

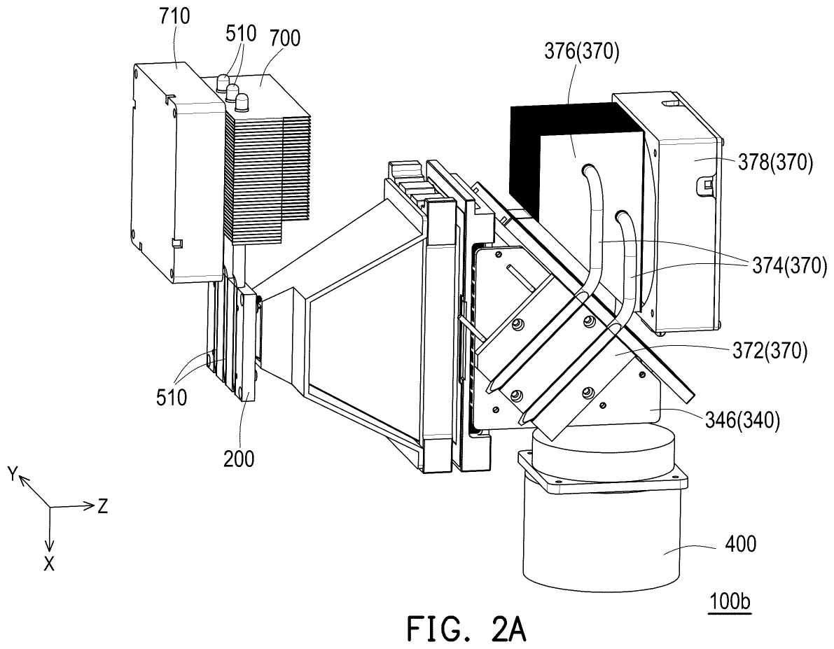

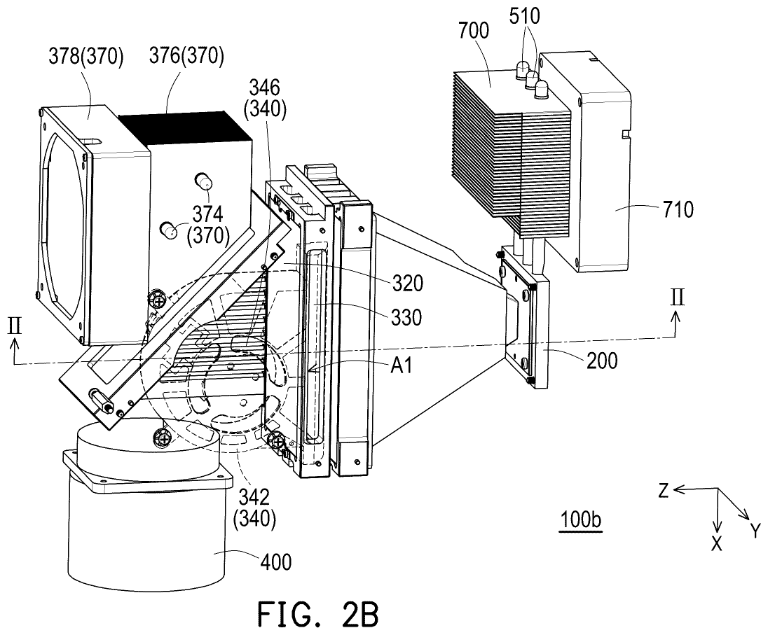

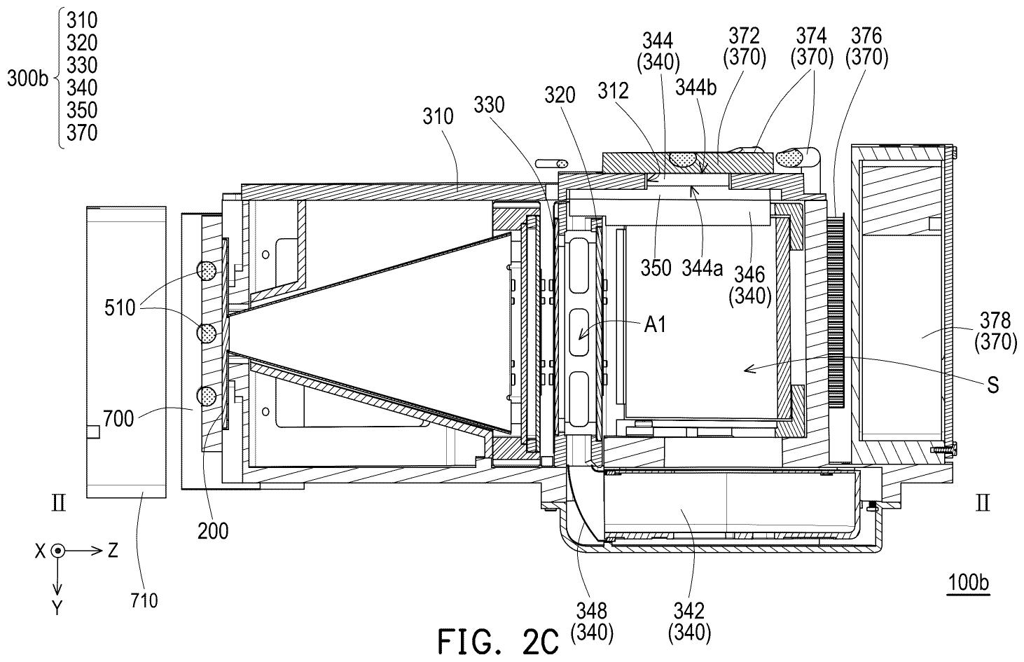

FIG. 2A is a schematic three-dimensional top view of a projection device according to another embodiment of the disclosure. FIG. 2B is a schematic three-dimensional bottom view of the projection device in FIG. 2A. FIG. 2C is a schematic cross-sectional view taken along the line II-II in FIG. 2B. It should be noted that, for the sake of clarity and ease of explanation, some components, such as the shell, are omitted from FIG. 2A and FIG. 2B, and some components are represented by dashed lines, such as the fan.

With reference to FIG. 1A, FIG. 1B, FIG. 1C, FIG. 2A, FIG. 2B, and FIG. 2C, a projection device 100b provided in the present embodiment is similar to the projection device 100a, while the main difference therebetween lies in that a light valve module 300b provide in the present embodiment further includes a second heat dissipation module 370 disposed outside the shell 310. The second heat dissipation module 370 includes a thermal conductive substrate 372, a light valve thermal conductive member 374, a second heat exchange element 376, and a system fan 378. The thermal conductive substrate 372 is connected to a hot surface 344b of the refrigeration element 344. The light valve thermal conductive member 374 is connected to the thermal conductive substrate 372 and the second heat exchange element 376, and the system fan 378 is disposed on one side of the second heat exchange element 376 to generate airflow flowing through the second heat exchange element 376 to reduce the temperature. In an embodiment, the second heat exchange element 376 may be, for instance, a heatsink, such as a needle-shaped heatsink or a plate-shaped heatsink, which should however not be construed as a limitation to the disclosure. In an embodiment, the system fan 378 is, for instance, an axial fan, which should however not be construed as a limitation to the disclosure.

Additionally, the projection device 100b provided in the present embodiment further includes a light source thermal conductive member 510, a third heat exchange element 700, and a fan 710. The light source thermal conductive member 510 is connected to the light source module 200 and the third heat exchange element 700, and the fan 710 is located on one side of the third heat exchange element 700 for generating airflow to flow through the third heat exchange element 700 to reduce the temperature. In an embodiment, the third heat exchange element 700 may be, for instance, a heatsink, such as a needle-shaped heatsink or a plate-shaped heatsink, which should however not be construed as a limitation to the disclosure. In an embodiment, the fan 710 is, for instance, an axial fan, which should however not be construed as a limitation to the disclosure. In short, in this embodiment, the light source module 200 and the light valve module 300b utilize separate heat exchange elements and fans for heat dissipation.

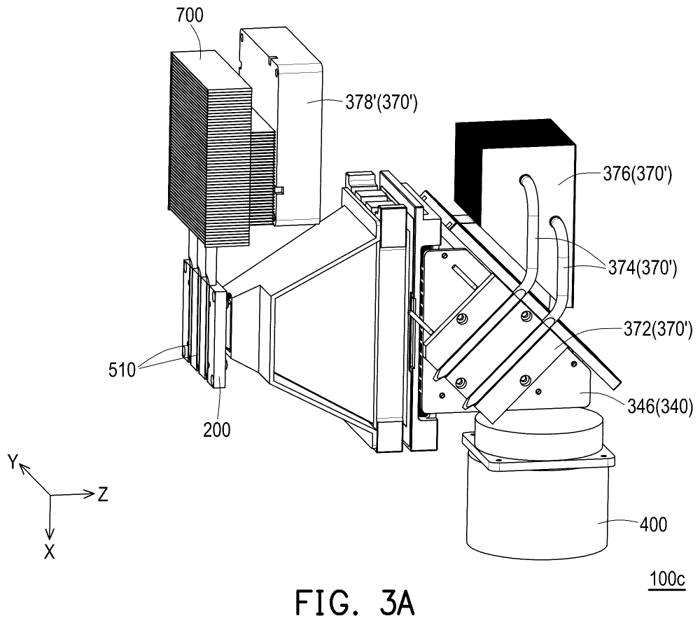

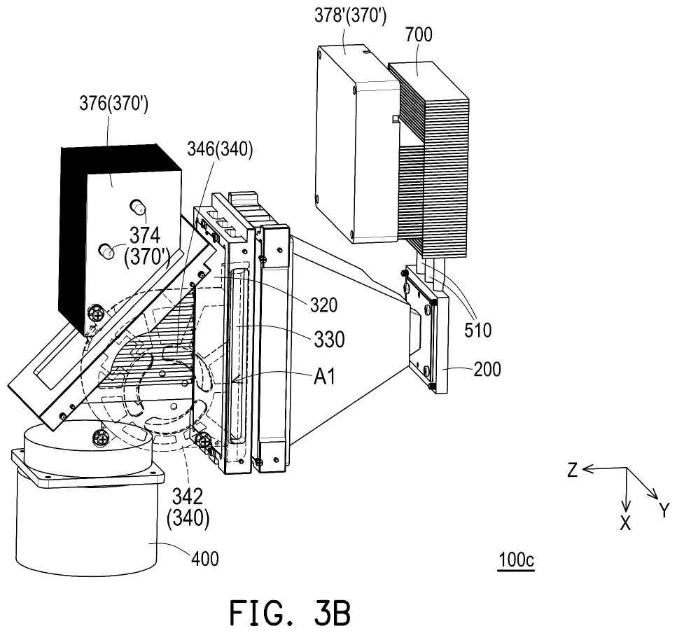

FIG. 3A is a schematic three-dimensional top view of a projection device according to another embodiment of the disclosure. FIG. 3B is a schematic three-dimensional bottom view of the projection device in FIG. 3A. It should be noted that, for the sake of clarity and ease of explanation, some components, such as the shell, are omitted from FIG. 3A and FIG. 3B, and some components are represented by dashed lines, such as the fan.

With reference to FIG. 2A, FIG. 2B, FIG. 3A, and FIG. 3B, a projection device 100c provided in this embodiment is similar to the projection device 100b, while the main difference therebetween lies in that a system fan 378′ of a second heat dissipation module 370′ provided in this embodiment is located between the second heat exchange element 376 and the third heat exchange element 700. In an embodiment, the second heat exchange element 376 is disposed at an air inlet end of the system fan 378′, and the third heat exchange element 700 is disposed at an air outlet end of the system fan 378′, allowing the airflow to sequentially flow through the second heat exchange element 376 and the third heat exchange element 700 before leaving the projection device 100b. In other words, in this embodiment, the light source module 200 and the light valve module may utilize the same system fan 378′ for heat dissipation, effectively reducing the overall volume of the projection device 100c.

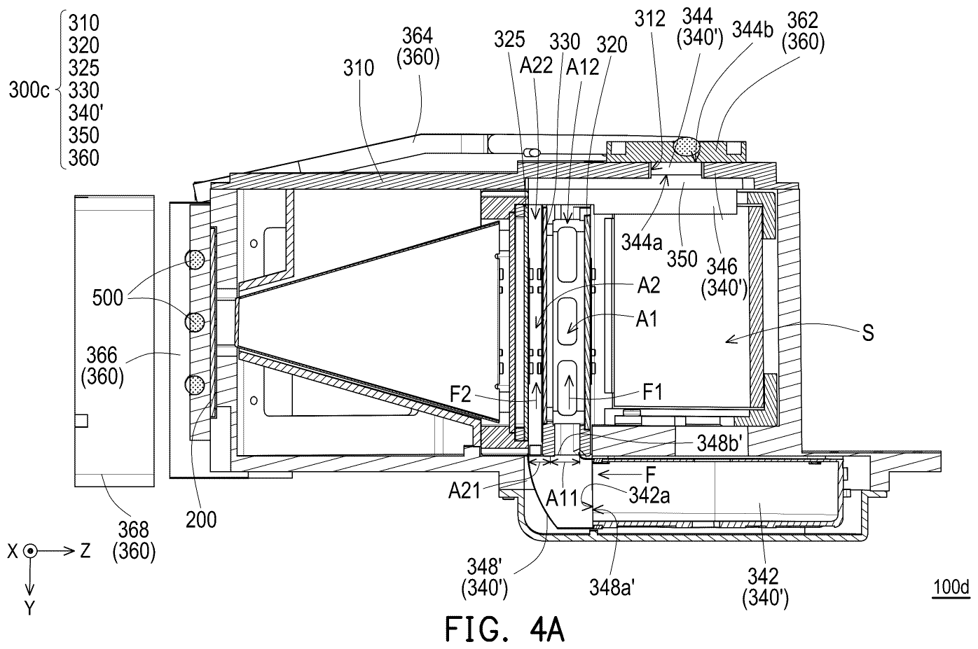

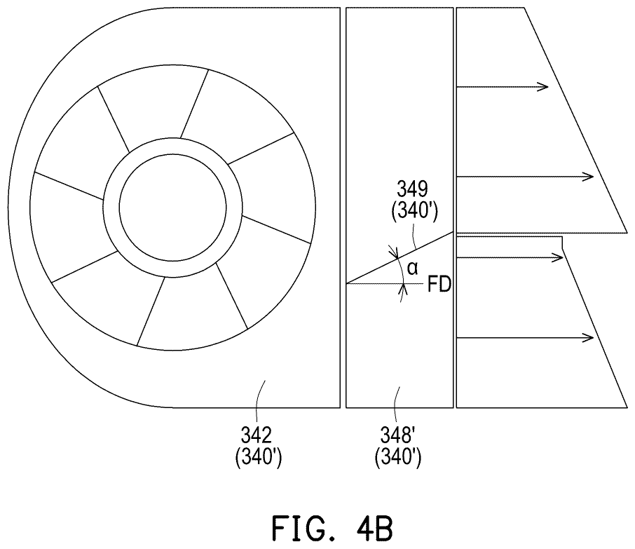

FIG. 4A is a schematic cross-sectional view of a projection device according to another embodiment of the disclosure. FIG. 4B is a schematic view of a cooling fan in the projection device in FIG. 4A. With reference to FIG. 1C and FIG. 4A, a projection device 100d provided in this embodiment is similar to the projection device 100a in FIG. 1C, while the main difference therebetween lies in that a light valve module 300c provided in this embodiment includes a focusing lens 325, the transmissive light valve 330 is located between the focusing lens 325 and the optical sheet 320, and the focusing lens 325 is configured to focus the image beam emitted by the transmissive light valve 330 to match the size of the lens module 400. A second airflow channel A2 is situated between the transmissive light valve 330 and the focusing lens 325, the air outlet 342a of the cooling fan 342 communicates with the first entrance port A11 of the first airflow channel A1 and the second entrance port A21 of the second airflow channel A2, and the first heat exchange element 346 is connected to the first exit port A12 of the first airflow channel A1 and the second exit port A22 of the second airflow channel A2.

In detail, with reference to FIG. 4A and FIG. 4B, a first heat dissipation module 340′ further includes an air guiding pipe 348′ and a partition board 349. The air guiding pipe 348′ is a bent pipe, which has a first end 348a′ and a second end 348b′. The first end 348a′ is connected to the air outlet 342a of the cooling fan 342, while the second end 348b′ is connected to the first entrance port A11 of the first airflow channel A1 and the second entrance port A21 of the second airflow channel A2. The partition board 349 is disposed in the air guiding pipe 348′ to divide the airflow F from the air outlet 342a of the cooling fan 342 into a first sub-airflow F1 entering the first airflow channel A1 and a second sub-airflow F2 entering the second airflow channel A2. The first sub-airflow F1 and the second sub-airflow F2 flow respectively in the corresponding first airflow channel A1 and second airflow channel A2, so as to perform impingement cooling on the first heat exchange element 346.

Specifically, an angle a is formed between the partition board 349 and an airflow direction FD of the cooling fan 342. In an embodiment, the angle α ranges from 15 degrees to 45 degrees. The angle a is defined along a rotation direction of fan blades of the cooling fan 342 and influences a flow field, which needs to be coordinated with the rotation of the fan blades. In particular, the partition board 349 is strategically positioned to defect the airflow direction FD along the rotation direction of the fan blades by the angle α. When the fan blades rotate counterclockwise, the airflow direction FD is deflected upward; on the contrary, when the fan blades rotate clockwise, the airflow direction FD is deflected downward. By inclining the partition board 349, the cooling fan 342 promotes a more uniform flow field and ensuring even airflow dispersion.

To sum up, at least one of the following advantages or effects is provided or achieved by one or more embodiments of the disclosure. In the design of the light valve module provided in one or more embodiments of the disclosure, the first heat dissipation module includes the cooling fan, the refrigeration element, and the first heat exchange element, where the cold surface of the refrigeration element is connected to the first heat exchange element and faces the first exit port of the first airflow channel between the optical sheet and the transmissive light valve. The length of the first heat exchange element located between the refrigeration element and the first exit port of the first airflow channel extends in the first direction, and in the first direction, the maximum distance from the edge of the extension end of the first heat exchange element to the optical sheet is greater than or equal to the distance from the optical axis of the lens module to the optical sheet, while the air inlet of the cooling fan faces the extension end of the first heat exchange element. This may enhance the cooling capacity inside the light valve module, and may make the airflow inside the light valve module flow in a uniform manner, thus accomplishing good heat dissipation performance and accordingly improving the brightness. In addition, the projection device using the light valve module provided in one or more embodiments of the disclosure may have good imaging quality.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light valve module, adapted to be connected to a lens module and comprising:
a shell, connected to the lens module;
an optical sheet, disposed in the shell;
a transmissive light valve, disposed in the shell, wherein a first airflow channel is situated between the optical sheet and the transmissive light valve; and
a first heat dissipation module, disposed in the shell and comprising a cooling fan, a refrigeration element, and a first heat exchange element, wherein the cooling fan comprises an air outlet and an air inlet, the air outlet communicates with a first entrance port of a first airflow channel, a cold surface of the refrigeration element is connected to the first heat exchange element and faces a first exit port of the first airflow channel, the first heat exchange element is located between the refrigeration element and the first exit port of the first airflow channel, a length of the first heat exchange element extends in a first direction, in the first direction, a maximum distance from an edge of an extension end of the first heat exchange element to the optical sheet is greater than or equal to a distance from an optical axis of the lens module to the optical sheet, and the air inlet of the cooling fan faces the extension end of the first heat exchange element.

2. The light valve module according to claim 1, wherein the first heat exchange element has at least one air passage, a direction from an entrance to an exit of each of the at least one air passage is parallel to the first direction, and the first direction is perpendicular to a second direction in which the first airflow channel extends.

3. The light valve module according to claim 1, wherein the first heat dissipation module further comprises an air guiding pipe, the air guiding pipe has a first end and a second end, the first end is connected to the air outlet of the cooling fan, the second end is connected to the first entrance port of the first airflow channel, and a diameter of the first end is greater than a diameter of the second end.

4. The light valve module according to claim 1, wherein the shell has an opening, the refrigeration element is positioned corresponding to the opening, a hot surface of the refrigeration element faces an outside of the shell, and the shell, the refrigeration element, the first heat exchange element, and a portion of the lens module define a sealed chamber.

5. The light valve module according to claim 1, further comprising a focusing lens, wherein the transmissive light valve is located between the focusing lens and the optical sheet, a second airflow channel is situated between the transmissive light valve and the focusing lens, and the air outlet of the cooling fan communicates with a second entrance port of the second airflow channel.

6. The light valve module according to claim 5, wherein the first heat dissipation module further comprises an air guiding pipe and a partition board, the air guiding pipe has a first end and a second end, the first end is connected to the air outlet of the cooling fan, the second end is connected to the first entrance port of the first airflow channel and the second entrance port of the second airflow channel, and the partition board is disposed in the air guiding pipe to divide an airflow from the air outlet of the cooling fan into a first sub-airflow entering the first airflow channel and a second sub-airflow entering the second airflow channel.

7. The light valve module according to claim 6, wherein an angle exists between the partition board and an airflow direction of the cooling fan, and the angle ranges from 15 degrees to 45 degrees.

8. The light valve module according to claim 1, further comprising a thermal interface material disposed between the first heat exchange element and the cold surface of the refrigeration element, wherein the first heat exchange element is connected to the refrigeration element through the thermal interface material.

9. The light valve module according to claim 1, further comprising a second heat dissipation module disposed outside the shell, the second heat dissipation module comprises a thermal conductive substrate, a light valve thermal conductive member, a second heat exchange element, and a system fan, the thermal conductive substrate is connected to a hot surface of the refrigeration element, the light valve thermal conductive member is connected to the thermal conductive substrate and the second heat exchange element, and the system fan is disposed on one side of the second heat exchange element.

10. The light valve module according to claim 9, further comprising at least one thermal barrier disposed between the first heat dissipation module and the second heat dissipation module, wherein the at least one thermal barrier is located between the shell and the thermal conductive substrate of the second heat dissipation module, located in a connection interface between the first heat exchange element of the first heat dissipation module and the thermal conductive substrate of the second heat dissipation module, or located between the shell and the thermal conductive substrate of the second heat dissipation module and located in a connection interface between the first heat exchange element of the first heat dissipation module and the thermal conductive substrate of the second heat dissipation module.

11. A projection device, comprising a light source module, a light valve module, and a lens module, wherein
the light source module is configured to provide an illumination beam;
the light valve module comprises:
a shell, connected to the lens module;
an optical sheet, disposed in the shell;
a transmissive light valve, disposed in the shell and located on a transmission path of the illumination beam for converting the illumination beam into an image beam, wherein a first airflow channel is situated between the optical sheet and the transmissive light valve; and
a first heat dissipation module, disposed in the shell and comprising a cooling fan, a refrigeration element, and a first heat exchange element, wherein the cooling fan comprises an air outlet and an air inlet, the air outlet communicates with a first entrance port of a first airflow channel, a cold surface of the refrigeration element is connected to the first heat exchange element and faces a first exit port of the first airflow channel, the first heat exchange element is located between the refrigeration element and the first exit port of the first airflow channel; and
the lens module is disposed on a transmission path of the image beam, at least one portion of the lens module is disposed in the shell, and the lens module is configured to project the image beam out of the projection device, wherein a length of the first heat exchange element extends in a first direction, in the first direction, a maximum distance from an edge of an extension end of the first heat exchange element to the optical sheet is greater than or equal to a distance from an optical axis of the lens module to the optical sheet, and the air inlet of the cooling fan faces the extension end of the first heat exchange element.

12. The projection device according to claim 11, wherein the first heat exchange element has at least one air passage, a direction from an entrance to an exit of each of the at least one air passage is parallel to the first direction, and the first direction is perpendicular to a second direction in which the first airflow channel extends.

13. The projection device according to claim 11, wherein the first heat dissipation module further comprises an air guiding pipe, the air guiding pipe has a first end and a second end, the first end is connected to the air outlet of the cooling fan, the second end is connected to the first entrance port of the first airflow channel, and a diameter of the first end is greater than a diameter of the second end.

14. The projection device according to claim 11, wherein the shell has an opening, the refrigeration element is positioned corresponding to the opening, a hot surface of the refrigeration element faces an outside of the shell, and the shell, the refrigeration element, the first heat exchange element, and the at least one portion of the lens module define a sealed chamber.

15. The projection device according to claim 11, further comprising a focusing lens, wherein the transmissive light valve is located between the focusing lens and the optical sheet, a second airflow channel is situated between the transmissive light valve and the focusing lens, and the air outlet of the cooling fan communicates with a second entrance port of the second airflow channel.

16. The projection device according to claim 15, wherein the first heat dissipation module further comprises an air guiding pipe and a partition board, the air guiding pipe has a first end and a second end, the first end is connected to the air outlet of the cooling fan, the second end is connected to the first entrance port of the first airflow channel and the second entrance port of the second airflow channel, and the partition board is disposed in the air guiding pipe to divide an airflow from the air outlet of the cooling fan into a first sub-airflow entering the first airflow channel and a second sub-airflow entering the second airflow channel.

17. The projection device according to claim 16, wherein an angle exists between the partition board and an airflow direction of the cooling fan, and the angle ranges from 15 degrees to 45 degrees.

18. The projection device according to claim 11, wherein the light valve module further comprises a thermal interface material disposed between the first heat exchange element and the cold surface of the refrigeration element, wherein the first heat exchange element is connected to the refrigeration element through the thermal interface material.

19. The projection device according to claim 11, wherein the light valve module further comprises a second heat dissipation module disposed outside the shell, the second heat dissipation module comprises a thermal conductive substrate, a light valve thermal conductive member, a second heat exchange element, and a system fan, the thermal conductive substrate is connected to a hot surface of the refrigeration element, the light valve thermal conductive member is connected to the thermal conductive substrate and the second heat exchange element, and the system fan is disposed on one side of the second heat exchange element.

20. The projection device according to claim 19, further comprising a light source thermal conductive member connected to the light source module and the second heat exchange element.

21. The projection device according to claim 19, further comprising at least one thermal barrier disposed between the first heat dissipation module and the second heat dissipation module, wherein the at least one thermal barrier is located between the shell and the thermal conductive substrate of the second heat dissipation module, located in a connection interface between the first heat exchange element of the first heat dissipation module and the thermal conductive substrate of the second heat dissipation module, or located between the shell and the thermal conductive substrate of the second heat dissipation module and located in a connection interface between the first heat exchange element of the first heat dissipation module and the thermal conductive substrate of the second heat dissipation module.

22. The projection device according to claim 19, further comprising a light source thermal conductive member and a third heat exchange element, wherein the light source thermal conductive member is connected to the light source module and the third heat exchange element, and the system fan is located between the second heat exchange element and the third heat exchange element.
